(19) United States
(12) Patent Application Publication
(10) Pub. No.: US 2011/0314005 A1
(43) Pub. Date: Dec. 22, 2011

(54) Determining and using search term weightings

(75) Inventor: Xiang Guo, Hangzhou (CN)

(73) Assignee: Alibaba Group Holding Limited

(21) Appl. No.: 13/134,825

(22) Filed: Jun. 16, 2011

(30) Foreign Application Priority Data
Jun. 18, 2010 (CN) 201010207880.1

(51) Int. Cl. G06F 17/30

(52) U.S. Cl. 707/723; 707/E17.014

(57) ABSTRACT

Determining search term weightings is disclosed, including: storing, in a search information log, a search query and corresponding information; generating a category distribution word list based at least in part on one or more stored search information logs; processing the category distribution word list based at least in part on a retrieved attribute word list; and determining a weighting corresponding to a search term associated with the processed category distribution word list. Using search term weighting is disclosed, including: receiving a subsequent search query; retrieving search term weightings corresponding to one or more search terms associated with the subsequent search query; searching indexed information using the one or more search terms associated with the subsequent search query; and ranking and presenting the indexed information corresponding to the one or more search terms based at least in part on the retrieved search term weightings.

### CROSS REFERENCE TO OTHER APPLICATIONS

This application claims priority to People's Republic of China Patent Application No. 201010207880.1 entitled METHOD AND DEVICE FOR DETERMINING SEARCH TERM WEIGHTINGS, AND METHOD AND DEVICE FOR GENERATING SEARCH RESULTS filed Jun. 18, 2010 which is incorporated herein by reference for all purposes.

### FIELD OF THE INVENTION

The present application involves the field of computer applications. In particular, it involves determining search term weightings and generating search results using search term weightings.

### BACKGROUND OF THE INVENTION

Information search systems are systems capable of providing users with information retrieval service. For example, an internet search engine (e.g., Google) is a type of information search system. Internet search engines have already become an indispensible utility for internet users. Typically, to use a search engine, a user accesses a webpage (e.g., via a web browser) associated with the search engine. At this webpage, the user will typically find a search box through which the user can submit a search query. After submitting the search query to the search engine (or a web server thereof), the search engine returns search results that match the user's query.

Search queries entered by users may include one or more search terms. When a search query entered by a user includes multiple search terms, typically, the search engine first parses the search query to obtain each of the multiple search terms. Next, the search engine uses the parsed out search terms to match for information at a database. Subsequent to finding information that matches one or more of the search terms, the search engine ranks the found information based on the relative importance of the search terms and it matches and presents these search results to the user (e.g., via a search results webpage accessible through the web browser).

Conventionally, the importance attributed to each search term is determined based on analyzing the statistics regarding the search terms. For example, some search engines keep track of the frequency that a particular search term appears in search queries. To do this, the search engines can record users' search query histories and occasionally analyze the frequency at which each search term appears among the recorded user search queries to determine a frequency corresponding to each search term. The frequency corresponding to a particular search term can determine the importance attributed to that search term; for example, a higher frequency can correlate with higher importance and a lower frequency can correlate with lower importance.

However, such conventional methods of attributing importance to search terms suffer in a few areas. First, recording user search histories can generate a voluminous amount of data on which statistical analysis is difficult to perform. Second, analyzing histories of user searches may overlook certain valuable search terms that have been infrequently searched. As a result of at least these problems, the ranking of search results may imprecisely reflect the order in which the user would desire to view them and also result in the user having to submit more, unnecessary search queries.

### BRIEF DESCRIPTION OF THE DRAWINGS

Various embodiments of the invention are disclosed in the following detailed description and the accompanying drawings.

In order to more clearly describe the technical proposals of the embodiments of the present disclosure or the existing technology, the following are brief overviews of the drawings that need to be used in describing the embodiments or existing technology; obviously, the drawings in the descriptions below are only some of the embodiments stated in the present disclosure; for ordinary technical personnel in this field, on the premise that no additional creative labor is expended, other drawings can be obtained.

FIG. 1 is a diagram showing an embodiment of a system for determining search term weightings and generating search results based on search term weightings;

FIG. 2 is a flow diagram showing an embodiment of a process for determining search term weightings;

FIG. 3 is a flow diagram showing an embodiment of a process for generating search results using search term weightings;

FIG. 4 is a diagram showing an embodiment of a system for determining search term weightings;

FIG. 5 is a diagram showing an embodiment of the word list optimization module; and

FIG. 6 is a diagram showing an embodiment of a system for generating search results.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Determining search term weightings and generating search results using search term weightings are disclosed. In various embodiments, a search term weighting determines how important that search term is considered to be. In performing a search with the terms of a search query, the information that matches a search term with a higher weighting is presented earlier among the search results than information that matches a search term with a lower weighting.

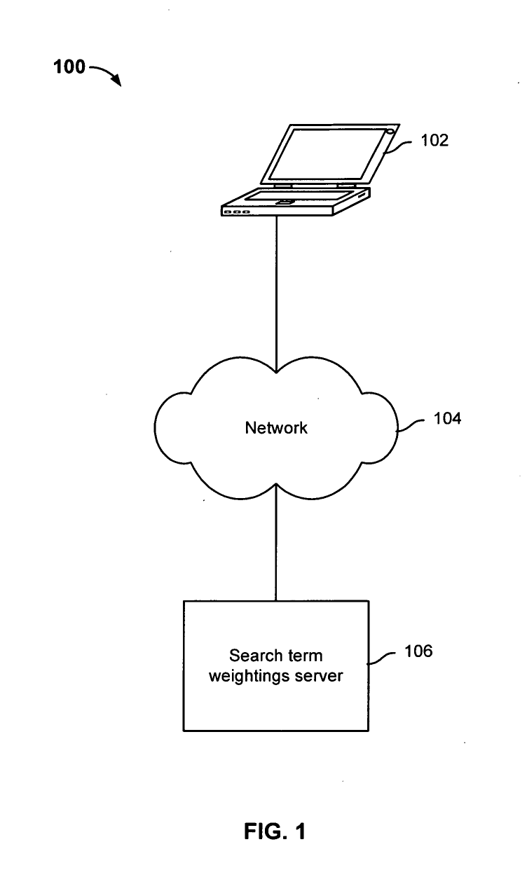

FIG. 1 is a diagram showing an embodiment of a system for determining search term weightings and generating search results based on search term weightings. System 100 includes device 102, network 104, and search term weightings server 106. In some embodiments, device 102 communicates with search term weightings server 106 via network 104. Network 104 includes one or more high speed data and/or telecommunications networks. In various embodiments, search term weightings server 106 is in communication with, in association with, and/or is a component of a web server that supports an electronic commerce website.

Device 102 is configured to allow a user to submit search queries and present search results returned in response to the submitted search queries. While device 102 is shown to be a laptop in the example FIG. 1, other examples of device 102 include, but are not limited to, a desktop computer, a mobile device, a smart phone, and a tablet device. In various embodiments, device 102 is configured with a software application, such as a web browser (e.g., Google's Chrome, Microsoft's Internet Explorer) that permits a user to access an electronic commerce website. At the electronic commerce website, a user can submit a search query at a webpage associated with the website and also receive search results at the same or different webpage. The user may browse and select among the search results.

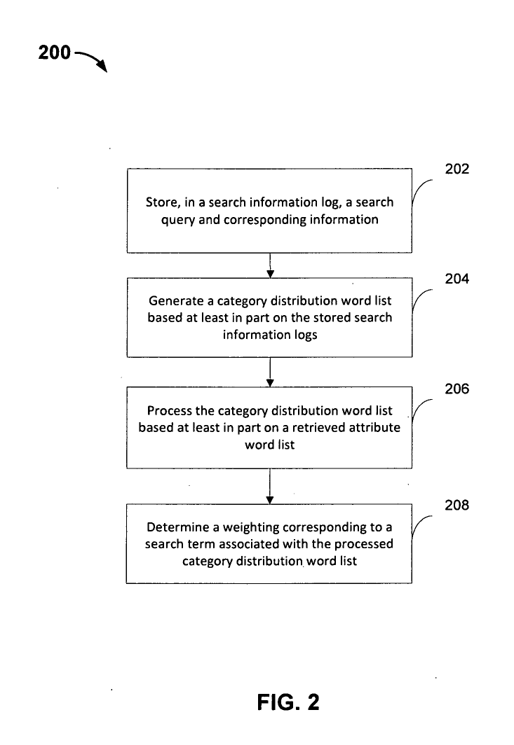

Search term weightings server 106 is configured to determine search term weightings. In various embodiments, search term weighting server 106 stores information associated with one or more user's search histories (e.g., search queries, search categories associated with the search queries, the number of times search results responsive to a search query was selected) as search information logs. In some embodiments, the search information logs are stored at a database (not shown in FIG. 1). The stored search information logs are analyzed from time to time to generate a category distribution word list. In some embodiments, the category distribution word list is a table that associates various search terms (from past search queries), search categories corresponding to the search terms, and corresponding statistics (e.g., probabilities) of the search categories. The category distribution word list represents for a search term, the percentage of times in which the search term was searched for under a particular search category (over the time in which the search information logs were stored). In some embodiments, the generated category distribution list is processed based at least in part on a predetermined attribute word list. The attribute word list includes attribute information related to products offered at the electronic commerce website. Examples of processing of the category distribution word list are described with FIG. 2. After processing, a weighting is determined for each search term of the category distribution word list. The weighting of a search term determines how important that search term is relative to other search terms. The higher the search term's corresponding weighting is, the more important that search term is considered to be. Examples of how to determine a weighting for a search term using the information from the category distribution word list is described below. In some embodiments, the determined search term weightings are stored so that they may be referenced to assist in future searching.

Search term weightings server 106 is also configured to use stored search term weightings to generate search results. In various embodiments, after search term weightings have been determined and stored, subsequent search queries are received. The search queries are matched against indexed information. The search queries are each parsed into one or more search terms. The search terms are located in the stored associations between search terms and weightings and the weightings corresponding to the located search terms are retrieved. The information matching to the parsed out search terms of the search queries is ranked based on the retrieved weightings corresponding to those search terms. In various embodiments, information that matches to search terms with higher weightings is presented to the querying user earlier among the search results than information that matches to search terms with lower weightings.

FIG. 2 is a flow diagram showing an embodiment of a process for determining search term weightings. In some embodiments, process 200 can be implemented, at least in part, by using system 100.

At 202, a search query and corresponding information is stored in a search information log.

In some embodiments, information corresponding to a search query includes one or more of the following: a search result responsive to the search query and a search category corresponding to the search query. In some embodiments, a search information log stores information relating to one search query and its corresponding information (e.g., selection of search results and one or more corresponding search categories). In some embodiments, search information logs can be stored at a database.

In some embodiments, the search query is submitted by a user to a search engine web server. The search query can include one or more words, which can also be referred to as search terms. The search engine web server then generates one or more search results (e.g., information that matches one or more search terms of the search query) for the search query. For example, the search results can be made accessible to the user via a webpage. The user then selects one or more of the displayed search results. The search engine web server can then store this information, including the search query and the number of selected search result(s) (and other information, such as search category information), as a search information log and/or transmit this information to another server (e.g., search term weightings server).

In some embodiments, a search result can include a link or Uniform Resource Locator (e.g., URL) to a webpage. In some embodiments, a search information log can include one or more of the following: a search query, search terms (e.g., parsed from the search query), and one or more search categories corresponding to one or more of the search terms, the number of times the user made a selection among search results, and any other appropriate information. More about search categories is described below.

In various embodiments, a search query (e.g., submitted by a user) corresponds to at least one search category. Generally, a significant amount of published information on the Internet is associated with a category. For example, at news information websites, webpages exist for news categories, such as news, sports, entertainment, finance and economics; at electronic commerce websites (e.g., www.alibaba.com), webpages exist for product categories, such as home, apparel, digital, and food, and webpages exist for product subcategories, such as mobile phones, cameras, and computers. In some embodiments, a search category corresponding to a search query is determined based on the category associated with the webpage at which the search query is submitted.

For example, at an electronic commerce website, suppose that a user submits the search query “cameras.” The user can submit the search query in association with a product category webpage of the electronic commerce website. For example, if the user searches for “cameras” under the consumer electronics category, then the search category which the search term “cameras” corresponds to is “consumer electronics”; or if the user searches “cameras” under the digital category, then the search category which the search term “cameras” corresponds to is “digital.”

In some embodiments, subsequent to receiving a search query, the search engine (e.g., associated with the webpage/website at which the search query was submitted) parses the search query (if it has more than one search term) into separate search terms. For example, the process of parsing a search query may include extracting words from the search query, discarding irrelevant information (e.g., characters for which there are no responsive search results), and/or storing each extracted word separately. In some embodiments, after parsing the search query, one or more search categories is determined for each parsed out search term of the search query. In various embodiments, the same search category corresponds to each of the parsed out search terms of the search query, and/or this same search category would also be the search category that corresponds to the entire search query (had the search category been assigned to an entire search query instead of to the individual, parsed out search terms of the search query). Put another way, the search categories associated with a search term are based on that instance of the search query in which the search term was a part. As such, the same search term can be associated with different search categories if that search term were searched at webpages associated with different search categories. For example, if a search query including “cameras” was searched at a webpage associated with the product category of “consumer electronics”, then in this instance of a search, the search term of “cameras” would correspond to the search category of “consumer electronics.” While, if another search query including “cameras” was searched at a webpage associated with the product category of “photography”, then in this instance of a search, the search term of “cameras” would correspond to the search category of “photography.”

For example, at an electronic commerce website, suppose a user submits the search query of “cameras SLR” under the consumer electronics category. The search query would first be parsed to obtain the separate search terms of “cameras” and “SLR.” Because both search terms were submitted (as part of the same search query) under the consumer electronics product category webpage of the website, the search category that corresponds to the search term “cameras” is “consumer electronics” and also, the search category that corresponds to the search term “SLR” is “consumer electronics.”

At 204, a category distribution word list based at least in part on the stored search information logs is generated.

In some embodiments, stored search information logs (e.g., stored over a predetermined period of time) are analyzed. In various embodiments, a category distribution word list is generated to represent the distribution of search categories corresponding to the search terms included in the analyzed search information logs. In various embodiments, for a search term included in the category distribution word list, the number of selections (e.g., of search results) for each of the search categories corresponding to that search term is also included.

As mentioned above, with respect to the same search term, when different users (or the same user at different times) perform searches using that search term, the corresponding search categories could be different. Therefore, in the stored search information logs, more than one distinct search category can correspond to the same search term. In 204, stored search information logs are analyzed such that for each of the search terms included in the logs, one or more search categories that correspond to that search term are determined, as well as the number of selections for each search category (i.e., the number of selections on search results returned for the search query/term associated with that search category), to generate distribution information for the search categories that correspond to that search term.

In some embodiments, the category distribution word list may be divided into (at least) two columns; the first column including the search term, and the second column including the search category distribution information corresponding to the search term. In some embodiments, the described search category distribution information may include one or more of the following: combinations of multiple search categories corresponding to the search term, and the number of selections corresponding to each individual search category corresponding to that search term. An example entry in the category distribution word list is as follows:

| | |
|---|---|
| Word | cat₁: selections₁; cat₂: selections₂; . . . catₙ: selectionsₙ |

Where Word is the search term; catᵢ is search category i corresponding to the search term; selectionsᵢ is the number of selections for search category i corresponding to the search term; i=1, 2, . . . n; and n is the number of search categories corresponding to the search term.

The example of using the search term of “cameras” at an electronic commerce website can be further addressed. While most users might search for “cameras” under a webpage associated with the product category of “consumer electronics,” some users might search for “cameras” under a webpage associated with the product category of “home appliances” or even generically under a webpage associated with the general product category of “all categories.” As mentioned for 202, search information logs are stored for such searches (with search queries including the search term of “cameras”). Then in 204, these search information logs (among others) are analyzed to obtain search category distribution information for at least the search term of “cameras.” Assume in this example that for the search term of “cameras,” the corresponding search categories found among the stored search information logs include “all categories,” “home appliances,” and “apparel,” and that the number of selections corresponding to those search categories, respectively, are 324, 1290, 34, and 8. So, the search category distribution information corresponding to the search term “cameras” is as follows:

| | |
|---|---|
| Cameras | All categories: 324; Digital: 1290; Home: 34; Apparel: 8 |

In various embodiments, in order to more clearly represent the distribution of the search categories corresponding to each search term, the number of selections corresponding to each search category can be expressed in the form of a probability. For example, the total number of selections corresponding to a search term is determined and then the search probability for a particular search category corresponding to that search term is determined as the number of selections for that category over the total number of selections corresponding to that search term. An example entry in the category distribution word list, including corresponding probabilities for the search categories, is as follows:

| | |
|---|---|
| Word | cat₁: p₁; cat₂: p₂; . . . catₙ: pₙ |

Where Word is the search term; catᵢ is search category i corresponding to the search term; pᵢ is the search probability for search category i corresponding to the search term; i=1, 2, . . . n; and n is the number of search categories corresponding to the search term.

Returning to the example of using the search term of “cameras” at an electronic commerce website, the corresponding search category distribution information list (including probabilities) entry is as follows:

| | |
|---|---|
| Cameras | All Categories: 19.6%; Digital: 77.9%; Home: 2%; |
| | Apparel: 0.5% |

In some embodiments, stored search information logs are analyzed periodically to update any existing search category distribution word list. For example, search information logs stored over a predetermined period (e.g., a week) can be automatically analyzed to update the category distribution word list. Or, an update to the category distribution information word list can be manually initiated (e.g., by an administrator of the search term weightings server).

At 206, the category distribution word list is processed based at least in part on a retrieved attribute word list.

In various embodiments, a website such as an electronic commerce website (or a web server thereof) can access a pre-stored attribute word list. In some embodiments, the attribute word list includes attribute information corresponding to each of at least a subset of products offered at the electronic commerce website. The attribute word list, for example, can be created by an administrator of the web server supporting the electronic commerce website and/or modified by third parties who offer products at the website. In some embodiments, the attribute word list is used to supply information to be displayed at webpages of corresponding products. In some embodiments, the information saved in the attribute word list includes information for which both the seller of a product (e.g., a business) and the buyer (e.g., a user who views webpages at an electronic commerce website) have interest in and is able to represent some useful features of the product.

For example, in the electronic commerce context, conventional attribute vocabulary generally includes one or more of product types, brands, model numbers, and colors. When a business that offers products at the electronic commerce website releases new or updated product information, the business or an administrator of the web server can update the attribute word list with this product information. Assuming that a business has recently released a new model of camera, the business can update the attribute word list to include the camera by adding an entry on the list corresponding to the new camera with the following information: the brand of the camera is “Canon,” the type is “SLR,” the model number is “D450,” and the color is “black.”

In some embodiments, information that is not particularly distinctive (e.g., a word that is commonly used to describe any number of types of products) is not stored as part of the attribute word list. Returning to the previous example of adding the new model of camera to the attribute word list, the attributes of “Canon,” “SLR,” and “D450” are considered to be capable of expressing a certain specific attribute of the camera, while “black” is a relatively popular word. As a consequence, “Canon,” “SLR,” and “D450” are added to the attribute word list, while “black” is not added to the attribute word list.

In various embodiments, the attribute information in the attribute word list that is similar is stored together (e.g., each attribute value is stored with a tag of its associated attribute). For example: “Canon” is stored together with other attribute values of the attribute of brand, and “SLR” is stored together with other attribute values of the attribute of type.

In various embodiments, the attribute word list is retrieved (e.g., from storage) and used in processing the category distribution word list generated in 204.

In various embodiments, the category distribution word list can be processed using the attribute word list. In some embodiments, it is first determined whether search terms included in the category distribution word list can be found in the attribute word list. For the search terms of the category distribution word list that can be found on the attribute word list, a step of filtering is applied to those search terms. For example, for the search terms of the category distribution word list that can be found on the attribute word list, those of their corresponding search categories' associated probabilities that do not reach or exceed a predetermined threshold are eliminated. This is to reduce the search categories that may not be as indicative of user's search intentions, such as those search queries that were performed under search categories that are not as relevant to the search terms of the queries. For the search terms of the category distribution word list that cannot be found on the attribute word list, a step of equalizing those search terms with respect to each corresponding search category is performed. Further descriptions of processing the category distribution word list with the attribute word list are as follows:

(1) Search terms of the category distribution word list that are found on the attribute word list:

Initially, it is determined which search terms included in the category distribution word list are also found on the attribute word list. Then, for those search terms of the category distribution word list that are found on the attribute word list, it is determined whether the probabilities of their corresponding search categories meet or exceed a predetermined threshold probability. The search categories whose corresponding probabilities do not meet or exceed the predetermined threshold probability are eliminated (i.e., filtered out) from the category distribution word list.

For example, in the context of an electronic commerce website, a user searches for the search term “cameras” in the “apparel” product category, which causes the generation of a search information log that includes “search term: cameras; search category: apparel.” However, it is apparent that “cameras” and “apparel” are unrelated, so there are likely relatively few user records of searches for “cameras” under the “apparel” category. By this rationale, such information (stored as search information logs) can be considered as a kind of interference information that is of little use to the facilitation of accurate searching of the website, and can, therefore be filtered out.

To illustrate this filtering out concept further, consider the following example: First, it is determined that the search term “cameras” belongs to the attribute word list. The search category distribution information extracted from the category distribution word list that corresponds to the search term “cameras” is as follows:

| | |
|---|---|
| Cameras | All Categories: 19.6%; Digital: 77.9%; Home: 2%; |
| | Apparel: 0.5% |

Then, search categories corresponding to the search term “cameras” with search probabilities lower than a predetermined threshold probability are filtered out. Specifically, assume that the predetermined threshold probability is 5%. After comparing each of the search probabilities with the predetermined threshold probability, it can be determined that the search probabilities of the search categories of “home” and “apparel” corresponding to the search term “cameras” are below 5%, and so those search categories (and their respective search probabilities) need to be eliminated (i.e., filtered out) from the category distribution word list. After filtering out the search categories of “home” and “apparel,” the updated search category distribution information for the search term “cameras” is as follows:

| | |
|---|---|
| Cameras | All Categories: 19.6%; Digital: 77.9% |

(2) Search terms of the category distribution word list that are not found on the attribute word list:

Those search terms of the category distribution word list that are not found on the attribute word list are equalized with respect to all of their corresponding search categories. The search terms of the category distribution word list that are not found on the attribute word list are considered to not indicate product attributes (of products at an electronic commerce website) but merely to limit the scope of the search results. For example, such search terms could include “red,” “beautiful,” and “inexpensive.” Because these search terms do not indicate the attributes of any particular products, these search terms may be used to describe and search for products in any search category. For example, they may be used to search for “cameras,” and they may also be used to search for “jackets,” because these search terms, generally, do not distinguish between products of different categories. In various embodiments, because such search terms are not saved to the attribute word list, when they appear among category distribution information, it is determined that such search terms are general or universal to all categories of products and thus cannot be used to distinguish (e.g., unique) products of different categories. As a consequence, the corresponding search probabilities of these universal search terms will be modified to be the same for each search category (i.e., equalized with respect to all corresponding search categories).

For example, assume that a user has searched with the search term “beautiful” and the search category distribution information corresponding to the search term “beautiful” is as follows:

| | |
|---|---|
| Beautiful | All Categories: 21.2%; Digital: 15.7%; Home: 35.4%′ |
| | Apparel: 27.8% |

After it is determined that the search term “beautiful” is not found on the attribute word list, equalization is performed with respect to the search probabilities of the various search categories corresponding to the search term “beautiful.” The distribution information for the search categories corresponding to the search term “beautiful” in the category distribution word list after equalization is as follows:

| | |
|---|---|
| Beautiful | All Categories: 25%; Digital: 25%; Home: 25%; |
| | Apparel: 25% |

In this example, the search probabilities of the search term “beautiful” were equalized with respect to each of the corresponding search categories such that the probability was the same for each search category. This was accomplished by dividing 100% by the total number of search categories (e.g., four, including “all categories,” “digital,” “home,” and “apparel”) and assigning that percentage as the new probability of each of those search categories. This is merely an example of equalization and equalization can be performed by other appropriate techniques as well. At 208, a weighting corresponding to a search term associated with the processed category distribution word list is determined.

In some embodiments, the information entropy method is used to determine the weighting of each of the search terms, which represent the degree of importance of a search term in the information searching process. As used herein, entropy is a measure of the degree of disorder of information content. The greater the entropy corresponding to a search term is, the greater the uncertainty that is expressed by the search term, and the less important, relatively the search term is. In some embodiments, the entropy corresponding to a search term serves as the weighting corresponding to that search term.

In various embodiments, the weighting of each search term is a value that is used to represent the degree of importance of the search term. The higher the weighting of a search term, the more important the search term is. The lower the weighting of a search term, the less important the search term is. From the perspective of a user performing a search at a website, the higher the weighting corresponding to a search term, the more likely that the user is interested in that search term. Consequently, searched information that matches to search terms with higher weightings is ranked higher among search results and presented to the user earlier than searched information that matches to search terms with lower weightings. This ordering is based on the assumption that the user would be more interested in viewing search results that match to search terms with high weightings.

In some embodiments, the determined weightings corresponding to search terms of the category distribution word list are stored. For example, the determined weightings corresponding to the search terms can be stored as entries (e.g., within a new column) in the table of the category distribution word list.

In some embodiments, the entropy value corresponding to each search term can be calculated based on the search probability distribution information corresponding to that search term in the category distribution word list.

In various embodiments, the number of search categories corresponding to each search term varies. In some embodiments, the total number of unique search categories for all the search terms in the category distribution word list is determined. The entropy for a search term is determined based on the searching probabilities for that search term and the total number of unique search categories.

For example, the following formula can be used to calculate the entropy corresponding to a search term in the category distribution word list:

C(Word)=|p₁ log(p₁)+p₂ log(p₂)+p₃ log(p₃)+ . . . +pₘ log(pₘ)|

Where Word is the search term; pᵢ is the search probability of search category i corresponding to the search term in the category distribution word list after processing, 0<pᵢ<1; i=1, 2, . . . m; and m is the total number of unique search categories included in the category distribution word list. In applying the above entropy formula for a particular search term, if the search term does not correspond to a particular search category among all the unique search categories of the category distribution word list, then the value of p with respect to that search category for that search term is zero (0).

Returning to the previous examples involving the search terms of “cameras” and “beautiful,” the respective processed search category distribution information are as follows:

| | |
|---|---|
| Cameras | All Categories: 19.6%; Digital: 77.9% |
| Beautiful | All Categories: 25%; Digital: 25%; Home: 25%; |
| | Apparel: 25% |

If the total number of unique search categories contained in the category distribution word list is 5 (i.e., m=5), then the respective entropies corresponding to the search terms “cameras” and “beautiful” are calculated as follows:

C(cameras)=|0.196×log 0.196+0.779×log 0.779+0×log 0+0×log 0+0×log0|

=0.2232

C(beautiful)=|0.25×log 0.25+0.25×log 0.25+0.25×log0.25+0.25×log 0.25+0×log0|

=0.602

In this example, the entropy for the search term “cameras” (0.2232) is less than the entropy for the search term “beautiful” (0.602) and thus the search term “beautiful” can be considered to be relatively less important compared to the search term of “cameras.”

In various embodiments, the lower the weighting (i.e., entropy) of a search term, the more important said search term is. Conversely, the higher the weighting (i.e., entropy) of a search term, the less important said search term is. However, these correlations may not conform to people's common style of thinking of weightings of importance. Generally, people may feel that the more important a search term is, the higher its weighting should be, and conversely, the less important a search term is, the lower its weighting should be.

Therefore, in various embodiments, the weightings for the search terms are adjusted to be in accordance with the notion that a higher weighting (i.e., entropy) correlates to a higher importance. This can be represented using, for example, the following formula:

WE(Word)=−C(Word)+C0

Where Word is the search term; WE(Word) expresses the weighting corresponding to the search term Word; C(Word) is the entropy corresponding to the search term Word; and C0 is the reference value.

In this formula, the value of C0 is chosen to be greater than the maximum value of the entropies corresponding to the search terms in the category distribution word list, and can be expressed as follows:

C0>max(C1, C2, . . . Cⱼ)

Where j is the total number of search terms contained in the category distribution word list.

In some embodiments, the value of C0 can be set prior to the determination of the entropies of the search terms of the category distribution word list. For example, the value of C0 can be chosen to be a value that is assumed to be very likely greater than any of the entropies that could be later determined for any of the search terms of the category distribution word list. In some embodiments, the value of C0 can be set subsequent to the determination of the entropies of the search terms of the category distribution word list. This way, the maximum entropy corresponding to a search term of the category distribution word list can be identified and then the value of C0 can be chosen to be higher than that maximum entropy value.

For example, suppose that the maximum value of entropies corresponding to the search terms of the category distribution word list is 0.99, so C0 can be set to equal 1. Applying the formula for adjusting weightings such that higher weighting (i.e., entropies) will correlate to higher importance, the new weightings for the search terms “cameras” and “beautiful” of the example are:

WE(cameras)=−0.2232+1=0.7768

WE(beautiful)=−0.602+1=0.398

Now, the weighting corresponding to the search term “cameras” (0.7768) is greater than the weighting corresponding to the search term “beautiful” (0.398), which indicates that the search term of “cameras” is considered to be more important than the search term of “beautiful.”

In various embodiments, stored weightings corresponding to search terms are retrieved from storage and used to assist in returning search results. Assuming that the determined weightings of the previous example were stored and retrieved, because the weighting corresponding to “cameras” is higher than the weighting corresponding to “beautiful,” the searched information that corresponds to “cameras” will be ranked higher than searched information that corresponds to “beautiful.”

In various embodiments, search terms can be associated with different types of information. Different types of information may be of varying degrees of interest for the user. For example, in the context of electronic commerce websites, search terms can generally be divided into the following types: product words, brand words, and attribute words. In some embodiments, product words are used to describe the category of a particular product, such as, for example, to which category of cameras, apparel, or foods a product belongs. In some embodiments, the brand words are used to describe the brand of a particular product, such as, for example, to which brand of Canon, Nikon, or Fuji a product belongs. In some embodiments, the attribute words are used to describe the unique attributes of the product, such as, for example, whether the product is an SLR and/or a memory card camera.

In various embodiments, an assignment of importance can be predetermined for each different type of search term. For example, in the context of electronic commerce websites, it can generally be considered that product words are of greater importance than brand words, and brand words are of greater importance than attribute words.

In various embodiments, the determined weightings for the search terms are adjusted based on the assignments of importance to types of information to which the search terms correspond. This is performed so that the adjusted weightings corresponding to the search terms can reflect the varying degrees of importance associated with the types of information for which the search terms represent.

In some embodiments, in the context of electronic commerce websites, the weightings corresponding to search terms that are identified as product words are adjusted to be greater than the weightings corresponding to search terms that are identified as brand words, while the weightings corresponding to search terms that are identified as brand words are adjusted to be greater than the weightings corresponding to search terms that are identified as attribute words.

For example, suppose that the weightings corresponding to the search terms “cameras,” “Canon,” and “SLR” (e.g., as obtained through the process of 200) are as follows:

WE(cameras)=0.7768

WE(Canon)=0.5982

WE(SLR)=0.8781

As can be seen from this example, WE(cameras) is greater than WE(Canon) and WE(Canon) is less than WE(SLR), i.e., the current weightings (before adjustment for the type of search term) satisfy the criterion that product word weightings are greater than brand word weightings, but the brand word weighting is less than the attribute word weighting, which fails to reflect the assumed higher importance of brand word over attribute word. As such, these weightings can be adjusted for the types of search terms, as discussed below.

First, the search terms of the category distribution word list are each classified into a type (e.g., product word, brand word, or attribute word). Then, if the types of search terms have not yet been assigned weighting adjustments (e.g., offset values to add to a determined weighting of a search term), the determination of the weighting adjustments for each type of search term is generated (e.g., by an administrator of the associated web server). A search term type with a higher degree of importance will have a higher weighting adjustment than a search term type with a lower degree of importance.

Next, adjustments for the weightings corresponding to search terms are made based on the types of search terms.

In some embodiments, weighting adjustments corresponding to the types of search terms are added to the weightings corresponding to the search terms.

For example, returning to the example involving the search terms of “cameras,” “Canon,” and “SLR”, the following adjusted weightings are generated:

WE′(cameras)=WE(cameras)+ΔWE(product word)

WE′(Canon)=WE(Canon)+ΔWE(brand word)

WE′(SLR)=WE(SLR)+ΔWE(attribute word)

As can be seen in this example, by adding the corresponding weighting adjustments (ΔWE(product word), ΔWE(brand word), and ΔWE(attribute word)) to the weightings (WE(cameras), WE(Canon), and WE(SLR)) corresponding to each type of search term (product word, brand word, and attribute word), the adjusted weightings are generated. After adjustment, the adjusted weightings (WE′(cameras), WE′(Canon), and WE′(SLR)) corresponding to search terms with a higher degree of importance are greater than the weightings corresponding to search terms with a lower degree of importance.

In this example, the weighting adjustments are set as follows: ΔWE(product words)=1, ΔWE(brand words)=0.8, and ΔWE(attribute words)=0.3. So the respective adjusted weightings for the search terms of “cameras,” “Canon,” and “SLR” are as follows:

WE′(cameras)=0.7768+1.0=1.7768

WE′(Canon)=0.5982+0.8=1.3982

WE′(SLR)=0.8781+0.3=1.1781

This adjustment causes WE′(cameras) to be higher than WE′(Canon), and WE′(Canon) to be higher than WE′(SLR), i.e., the adjusted weightings satisfy the criterion of product word weightings being higher than brand word weightings and brand word weightings being higher than attribute word weightings.

In various embodiments, after the weightings corresponding to search terms are adjusted based on search term types, the adjusted weightings become the new weightings for the search terms and are stored. In various embodiments, the weightings corresponding to search terms are to be used in generating search results in response to subsequent search queries.

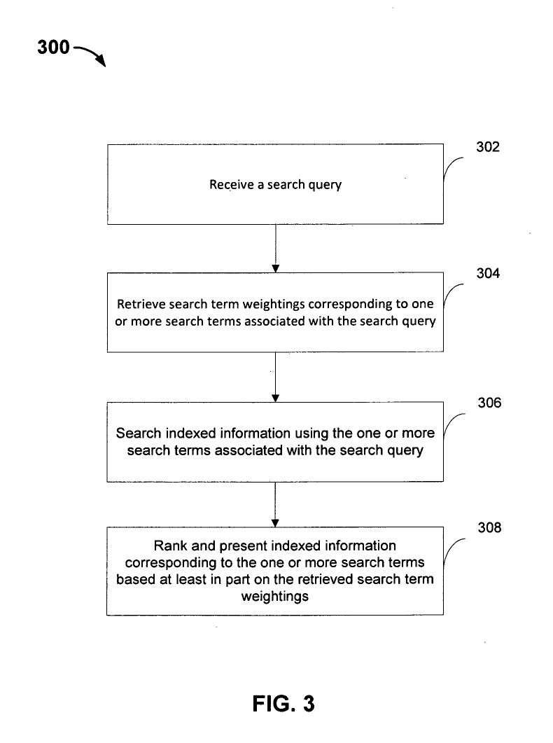

FIG. 3 is a flow diagram showing an embodiment of a process for generating search results using search term weightings. In some embodiments, process 300 can be implemented, at least in part, using system 100.

At 302, a search query is received.

In some embodiments, the search query is submitted at a website. For example, the website is associated with electronic commerce and the search query relates to product(s) offered by the website. In some embodiments, the received search query (e.g., that includes one or more words) is parsed into separate search terms. If the search query is only one word, the search term obtained after the parsing is the search query itself. For example, if the search query were “cameras,” then the search term would be “cameras.” If the search query includes multiple words, then multiple search terms would be obtained after the parsing process. For example, if the search query were “cameras beautiful,” then the search terms would be “cameras” and “beautiful.”

At 304, search term weighting(s) corresponding to one or more search terms associated with the search query are retrieved.

In various embodiments, stored associations of search terms and their corresponding weightings are searched to find the corresponding weightings of the search terms of the search query received at 302. In various embodiments, the associations or correspondences between search terms and their weightings are determined by a process such as process 200.

For example, for the search query that includes the search terms “cameras” and “beautiful,” the retrieved weightings for those terms are as follows:

WE(cameras)=0.7768

WE(beautiful)=0.398

At 306, indexed information is searched using the one or more search terms associated with the search query.

In various embodiments, the information against which the search terms of the search query are searched for is indexed. The information can be indexed in one or more ways to facilitate the searching. For example, the information can be indexed by associated tag words. In various embodiments, the information is stored in a database associated with an electronic commerce website. For example, information associated with an electronic commerce website could include content of and/or links to webpages that feature information on various products sold by businesses at the website. In some embodiments, the information searched includes information (e.g., webpage content and links) that is crawled and managed by a search engine service (e.g., Google, Microsoft's Bing, etc.).

In some embodiments, each separate search term is searched against the indexed information, one at a time, until all the search terms of the search query have been used in searching. In some embodiments, all search terms are searched against the indexed information at once. In some embodiments, the indexed information that matches each search term is associated with that search term. In some embodiments, the same information can be matched to more than one search term. For example, all the information that matches with a particular search term could be temporarily stored with an identifier associated with that search term. This is to assist in the ranking of matched information, which is performed based on the search terms corresponding to the matched information.

At 308, indexed information corresponding to the one or more search terms is ranked and presented based at least in part on the retrieved search term weightings.

Searched information that matches to search terms is ranked before the matched information is presented to the user. One reason for ranking the information is so that information can be presented to the user based on an order that is assumed to be desirable to the user. Search results (e.g., information matching to the search terms) that are assumed to be of greater importance (e.g., more interest) to the user are preferred to be presented to the user earlier than search results that are of comparatively lower importance. In various embodiments, the matched information is ranked (i.e., ordered) based on the corresponding weightings to the search terms with which they have been found to match in 306. In various embodiments, matching information is presented in descending order based on the corresponding weightings to the search terms with which they have been found to match. For example, information that matches a search term with a first weighting will be ranked higher and presented earlier than information that matches another search with a second weighting that is lower than the first weighting. In some embodiments, the weighting corresponding to a search term determines whether the search term is a “subject” search term or an “auxiliary” search term. When the weighting corresponding to a search, term is greater than a predetermined threshold value, the described search term is determined to be a “subject” search term; otherwise, the search term is determined to be an “auxiliary” search term.

The significance in dividing search terms into “subject” and “auxiliary” search terms is a difference in searching indexed information using the search terms. When performing searches based on the search terms included in the search query, more focus is placed on “subject” search terms. For example, searched information that matches the “subject” search terms are necessarily ranked in the search results while search information that matches the “auxiliary” search terms are not necessarily ranked in the search results. If there is an appropriate amount of search results matching to the “subject” search terms, then information matching “auxiliary” search terms need not be presented to the user at all. However, if information matching “auxiliary” search terms are to be presented to the user (e.g., because there are not enough search results matching the “subject” search terms alone), then the information matching to the “auxiliary” search terms can be ranked higher than search results that do not match either the “auxiliary” search terms or the “subject” search terms.

In some embodiments, the ranked search results are presented to the user (who submitted the search query in 302) via a search results webpage. The user can access this webpage using a web browser. In some embodiments, the search results include one or more of links to webpages that contain information (e.g., regarding products sold by businesses at an electronic commerce website) and information directly displayed at the search results webpage (e.g., blurbs about product attributes).

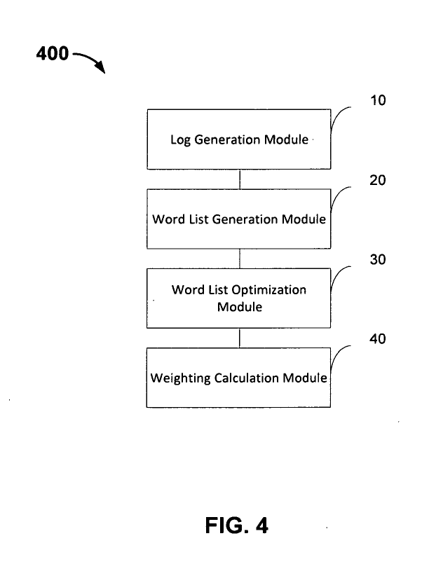

FIG. 4 is a diagram showing an embodiment of a system for determining search term weightings. In some embodiments, the modules of system 400 are implemented in association with or as a component of a web server supporting an electronic commerce website. In some embodiments, process 200 can be implemented at least in part by system 400.

The modules can be implemented as software components executing on one or more processors, as hardware, such as programmable logic devices and/or Application Specific Integrated Circuits designed to perform certain functions, or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices.

Log generation module 10 is configured to receive search queries and search result selection information submitted by users (of the electronic commerce website), and generate search information logs. In some embodiments, the generated search information logs are saved to a database.

Word list generation module 20 is configured to analyze the stored search information and generate the category distribution word list based at least in part on the analysis. In some embodiments, the category distribution word list includes search terms, search categories corresponding to the search terms, and search probabilities corresponding to each of the search categories corresponding to the search terms.

Word list optimization module 30 is configured to extract the attribute word list (e.g., from a storage/database associated with the electronic commerce website web server) and process the category distribution word list.

Weighting calculation module 40 is configured to determine weightings for each of the search terms contained in the category distribution word list, based at least in part on the category distribution after it has been processed by word list optimization module 30.

In some embodiments, system 400 also optionally includes the following modules, which are not shown in FIG. 4:

A classification module configured to classify the search terms contained in the category distribution word list and determine the degree of importance for each type of search term. In some embodiments, the search terms are each sorted or classified into the search term types of product word, brand word or attribute word. In some embodiments, each of the search term types is associated with a different degree of importance.

A correction module configured to adjust the weightings of the search terms of the category distribution word list based on the type of each search term (as determined by the classification module).

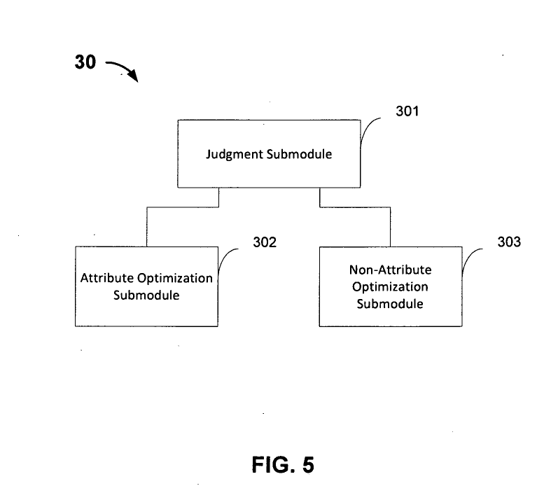

FIG. 5 is a diagram showing an embodiment of the word list optimization module. In some embodiments, word list optimization module 30 of FIG. 4 can be implemented, at least in part, using the example of FIG. 5.

Judgment submodule 301 is configured to determine which search terms included in the category distribution word list are found in the attribute word list. In some embodiments, judgment submodule 301 is also configured to create a list for search terms of the category distribution word list that are found in the attribute word list and another list for search terms that are not found in the attribute word list.

Attribute word list optimization submodule 302 is configured to determine, for each search term of the category distribution word list that is found in the attribute word list, corresponding search categories that have search probabilities lower than a predetermined threshold value.

Non-attribute word list optimization submodule 303 is configured, for each search term of the category distribution word list that is not found in the attribute word list, to equalize the search probabilities of all search categories corresponding to the search term. In some embodiments, to equalize the search probabilities of all search categories corresponding to the search term includes assigning the average of all their search probabilities to each search category to replace their originally determined search probability.

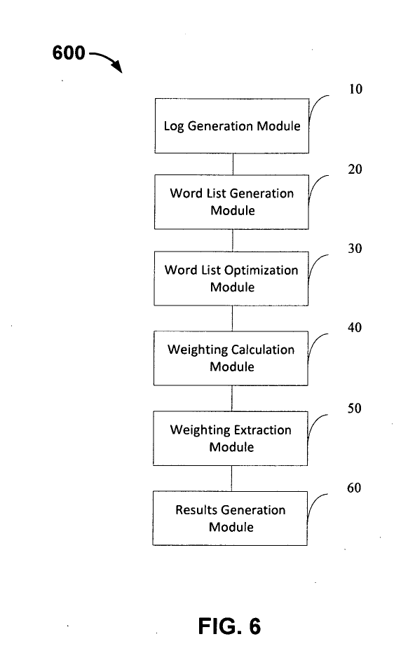

FIG. 6 is a diagram showing an embodiment of a system for generating search results. In some embodiments, system 600 is system 400 (which includes log generation module 10, word list generation module 20, word list optimization module 30, and weighting calculation module 40) with the addition of weighting extraction module 50 and results generation module 60. Modules described with FIG. 4 will not be explained further below. In some embodiments, process 300 can be implemented at least in part by system 600.

Weighting extraction module 500 is configured to receive search queries entered by users and retrieve weightings corresponding to each of the search terms in the search queries. In some embodiments, weighting extraction module 500 is also configured to parse each received search query into one or more search terms.

Result generation module 600 is configured to rank searched information that matches to each of the search terms based at least in part on the weighting corresponding to each of the search terms.

For convenience of description, when describing the device above, each module is described separately according to its function. Of course, during implementation of the present disclosure, the functions of the various units may be achieved in the same or multiple software and/or hardware configurations.

As can be seen through the description of the implementation means above, technical personnel in this field can clearly understand that the present disclosure can be realized with the aid of software plus the necessary common hardware platform. Based on such an understanding, the technical proposal of the present disclosure, whether intrinsically or with respect to portions that contribute to the existing technology, is realizable in the form of software products; said computer software products can be stored on storage media, such as ROM/RAM, diskettes, and compact discs, and include a certain number of commands used to cause a set of computing equipment (which could be a personal computer, server, or network equipment) to execute the means or certain portions of the means described in the embodiments of the present disclosure.

Each of the embodiments contained in the present disclosure is described in a progressive manner, and the descriptions thereof may be mutually referenced for portions of each embodiment that are identical or similar; the explanation of each embodiment focuses on areas of difference from the other embodiments. In particular, with regard to the system embodiments, because they are fundamentally similar to the method embodiments, the descriptions are relatively simple; portions of the explanation of the method embodiments can be referred to for the relevant aspects. The system embodiments described above are only schematic; elements therein described as separate parts may or may not be physically separate, and parts shown as elements may or may not be physical elements, i.e., they may be located in one place, or they may be distributed onto multiple network elements. A portion or all of the modules herein may be chosen based on actual requirements to achieve the objectives of the current embodiments. Ordinary technical personnel in this field will be able to understand and implement it without expending creative labor.

The present disclosure can be used in many general purpose or specialized computer system environments or configurations. Examples of these include personal computers, servers, handheld devices or portable equipment, tablet type equipment, multiprocessor systems, microprocessor-based systems, set-top boxes, programmable consumer electronic equipment, networked PCs, minicomputers, mainframe computers, distributed computing environments that include any of the systems or equipments above, and so forth.

The present disclosure can be described in the general context of computer executable commands executed by a computer, such as a program module. Generally, program modules include routines, programs, objects, components, data structures, etc., to execute specific tasks or achieve specific abstract data types. The present disclosure can also be carried out in distributed computing environments; in such distributed computing environments, tasks are executed by remote processing equipment connected via communication networks. In distributed computing environments, program modules can be located on storage media at local or remote computers that include storage equipment.

The description above is only a specific means of implementing the present disclosure; it should be pointed out that ordinary technical personnel in this field of technology, on the premise of non-departure from the principles of the present disclosure, can also produce a number of improvements and embellishments, and that such improvements and embellishments should also be regarded as within the scope of protection of the present disclosure.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of facilitating search, comprising:
storing, in a search information log, a search query and corresponding information;
generating a category distribution word list based at least in part on one or more stored search information logs;
processing the category distribution word list based at least in part on a retrieved attribute word list; and
determining a weighting corresponding to a search term associated with the processed category distribution word list.

2. The method of claim 1, further comprising storing the determined weighting corresponding to the search term associated with the processed category distribution word list.

3. The method of claim 2, further comprising:
receiving a subsequent search query;
retrieving search term weightings corresponding to one or more search terms associated with the subsequent search query;
searching indexed information using the one or more search terms associated with the subsequent search query; and
ranking and presenting the indexed information corresponding to the one or more search terms based at least in part on the retrieved search term weightings.

4. The method of claim 3, further comprising parsing the subsequent search query into one or more search terms.

5. The method of claim 1, wherein the corresponding information to the search query includes one or more of the following: one or more search terms, one or more selections associated with search results returned in response to the search query, and one or more search categories corresponding to the one or more search terms.

6. The method of claim 1, wherein an entry associated with the category distribution word list includes a search term, corresponding one or more search categories and search probabilities corresponding to the one or more search categories.

7. The method of claim 1, wherein the retrieved attribute word list includes information on one or more products sold at an associated electronic commerce website.

8. The method of claim 1, wherein processing the category distribution word list based at least in part on a retrieved attribute word list includes determining whether a search term associated with the category distribution word list is found on the attribute word list;
in the event that the search term is found on the attribute word list, determining whether a search probability associated with the search term exceeds a predetermined threshold probability, in the event that the search probability does not exceed the predetermined threshold probability, filtering out the associated search term; and
in the event that the search term is not found on the attribute word list, equalizing the search term with respect to all search categories associated with the search term.

9. The method of claim 1, wherein determining a weighting corresponding to a search term includes calculating an entropy value associated with the search term based at least in part on one or more probabilities corresponding to one or more search categories corresponding to the search term.

10. The method of claim 9, further comprising classifying the search term associated with the category distribution word list into a type and adjusting the weighting corresponding to the search term based at least in part on the classified type of the search term.

11. The method of claim 3, wherein ranking and presenting the indexed information includes giving a higher ranking to a first search term that corresponds to a higher weighting than a second search term that corresponds to a lower weighting.

12. A system, comprising:
a processor configured to:
store, in a search information log, a search query and corresponding information,
generate a category distribution word list based at least in part on one or more stored search information logs,
process the category distribution word list based at least in part on a retrieved attribute word list, and
determine a weighting corresponding to a search term associated with the processed category distribution word list; and
a memory coupled to the processor and configured to provide the processor with instructions.

13. The system of claim 12, wherein the processor is further configured to store the determined weighting corresponding to the search term associated with the processed category distribution word list.

14. The system of claim 13, wherein the processor is further configured to:
receive a subsequent search query;
retrieve search term weightings corresponding to one or more search terms associated with the subsequent search query;
search indexed information using the one or more search terms associated with the subsequent search query; and
rank and present the indexed information corresponding to the one or more search terms based at least in part on the retrieved search term weightings.

15. The system of claim 14, wherein the processor is further configured to parse the subsequent search query into one or more search terms.

16. The system of claim 12, wherein the corresponding information to the search query includes one or more of the following: one or more search terms, one or more selections associated with search results returned in response to the search query, and one or more search categories corresponding to the one or more search terms.

17. The system of claim 12, wherein an entry associated with the category distribution word list includes a search term, corresponding one or more search categories and search probabilities corresponding to the one or more search categories.

18. The system of claim 12, wherein the retrieved attribute word list includes information on one or more products sold at an associated electronic commerce website.

19. The system of claim 12, wherein to process the category distribution word list based at least in part on a retrieved attribute word list includes the processor configured to determine whether a search term associated with the category distribution word list is found on the attribute word list;
in the event that the search term is found on the attribute word list, determine whether a search probability associated with the search term exceeds a predetermined threshold probability, in the event that the search probability does not exceed the predetermined threshold probability, filter out the associated search term; and
in the event that the search term is not found on the attribute word list, equalize the search term with respect to all search categories associated with the search term.

20. The system of claim 12, wherein to determine a weighting corresponding to a search term includes the processor configured to calculate an entropy value associated with the search term based at least in part on one or more probabilities corresponding to one or more search categories corresponding to the search term.

21. The system of claim 20, wherein the processor is further configured to classify the search term associated with the category distribution word list into a type and adjust the weighting corresponding to the search term based at least in part on the classified type of the search term.

22. The system of claim 14, wherein to rank and present the indexed information includes the is processor configured to give a higher ranking to a first search term that corresponds to a higher weighting than a second search term that corresponds to a lower weighting.

23. A computer program product, the computer program product being embodied in a computer readable storage medium and comprising computer instructions for:
storing, in a search information log, a search query and corresponding information;
generating a category distribution word list based at least in part on one or more stored search information logs;
processing the category distribution word list based at least in part on a retrieved attribute word list; and
determining a weighting corresponding to a search term associated with the processed category distribution word list.
